(19) United States
(12) Patent Application Publication
(10) Pub. No.: US 2016/0064990 A1
(43) Pub. Date: Mar. 3, 2016

(54) NEAR FIELD COMMUNICATION AND WIRELESS CHARGING DEVICE

(71) Applicant: Foxconn Technology Co., Ltd., New Taipei (TW)

(72) Inventors: YUNG-PING LIN, New Taipei (TW); QIU-RI ZHANG, New Taipei (TW); CHIA-CHIN LEE, New Taipei (TW)

(21) Appl. No.: 14/686,082

(22) Filed: Apr. 14, 2015

(30) Foreign Application Priority Data
Aug. 28, 2014 (CN) 201410429923.9

(51) Int. Cl. H02J 7/02; H02J 7/00

(52) U.S. Cl. CPC H02J 7/025; H02J 7/0042

(57) ABSTRACT

A near field communication and wireless charging device includes a main body, a electronic circuit, a NFC module, a wireless charging module coupled to the electronic circuit. The NFC module and the wireless charging module are arranged independently. Further included a electrical connector, a first end of the electrical connector is coupled to the electronic circuit and a second end of the electrical connector is extending to outside of the main body to attaching to the electrical device bendingly.

### CROSS-REFERENCE TO RELATED APPLICATIONS

This application claims priority to Chinese Patent Application No. 201410429923.9 filed on Aug. 28, 2014 in the State Intellectual Property Office of the P. R. C, the contents of which are incorporated by reference herein.

### FIELD

The disclosure relates to a near field communication and wireless charging device for electric device having not the near communication and wireless charging function.

### BACKGROUND

An electrical device, such as a mobile phone, a notebook, includes a Near Field Communication (NFC) module and a wireless charging module. The NFC module and the wireless charging module are coupled to a electronic circuit of the electrical device.

### BRIEF DESCRIPTION OF THE DRAWINGS

Implementations of the present technology will now be described, by way of example only, with reference to the attached figures.

FIG. 1 is a cross section view of a near field communication and wireless charging device of a first embodiment.

FIG. 2 is a cross section view of a near field communication and wireless charging device coupled to the electrical device.

FIG. 3 is a cross section view of a near field communication and wireless charging device connecting to the electrical device.

FIG. 4 is a cross section view of a near field communication and wireless charging device of a second embodiment.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected. The term “electronically coupled” can include any coupling that is via a wired or wireless connection. The electronic coupling can be through one or more components or it can include a direct connection between the described components.

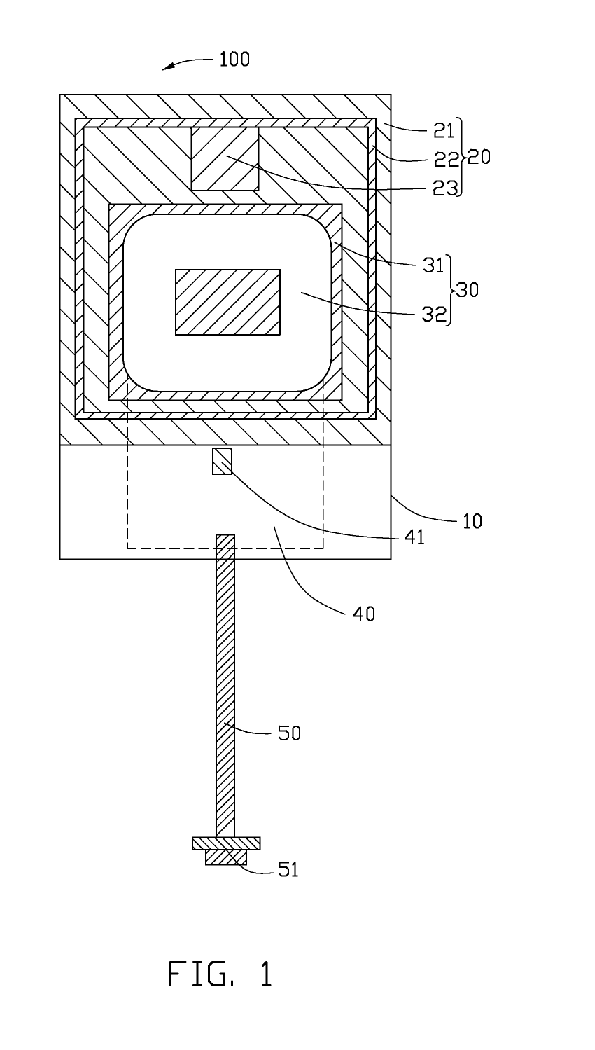

FIG. 1 illustrates a near field communication and wireless charging device 100 of a first embodiment. The near field communication and wireless charging device 100 includes a main body 10, a NFC (Near Field Communication) module 20, a wireless charging module 30, a electronic circuit 40 received in the main body 10 and a electrical connector 50. The electrical connector 50, the wireless charging module 30 is electrically coupled with the electronic circuit 40.

In at least one embodiment, the main body 10 is rectangular and is made of soft non-metallic materials, such as plastic, rubber. The main body 10 has an exterior outer surface. The length of the main body 10 may be 7 mm, the width of the main body 10 may be 5 mm, and the height of the main body 10 may be 2 mm, it can be understood that the above size of the main body 10 may depend upon different demands accordingly.

The NFC module 20 is mounted on a side of the main body 10 and coupled with the electronic circuit 40. The NFC module 20 includes a spacer 21, a NFC coil 22 and a NFC chip 23 located on a side of the spacer 21. The spacer 21 is configured to gather magnetic signals to the NFC coil 22. The spacer 21 is a rectangular plate. The spacer 21 has a groove in a central portion of the spacer 21 to receive the wireless charging module 30 therein. In at least one embodiment, the NFC soil 22 is a rectangular frame and is around the periphery areas of the spacer 21 to receive magnetic signals. The NFC chip 23 is configured for accepting the magnetic signals from the NFC soil 22 and converts the magnetic signals into electrical signals. The NFC chip 23 is surrounded by the NFC coil 22 and is electrically coupled to the NFC coil 22. The NFC chip 23 is spaced with the wireless charging module 30. The electric signals from the NFC module 20 is conducted to the electronic circuit 40 by the NFC chip 23.

The wireless charging module 30 is mounted on the spacer 21 of the NFC module 20. The wireless charging module 30 is surrounded by the NFC coil 22. The wireless charging module 30 includes a base 31 and a receiving soil 32 mounted on the baser 31. In at least one embodiment, the receiving soil 32 and the base 31 are rectangular. The center of the receiving soil 32 is a hole through the receiving soil 32. The receiving soil 32 receives magnetic signals and coverts the magnetic signal into electrical signals. The base 31 gathers magnetic signal to improve the utilization of the magnetic signals. The wireless charging module 30 may have a single receiving soil 32. Alternatively, the wireless charging module 30 may have a plurality of receiving coils 32, and the plurality of receiving coils 32 each may have a different configuration.

The electronic circuit 40 is mounted on a side of the main body 10 and located at an end of the receiving coil 32 and is adjacent to the electrical connector 50. The electronic circuit 40 is coupled to the receiving coil 32 of the wireless charging module 30 and the electrical connector 50. A controlling unit 41 is mounted on a side of the electronic circuit 40 and is coupled to the electronic circuit 40. The controlling unit 41 coverts the electrical energy into suitable electrical energy for the electrical device. The electrical signals from the wireless charging module 30 and the NFC module 20 enter the controlling unit 41 via the electronic circuit 40. The controlling unit 41 converts the intensity and frequency of the electrical signals and transmits the electrical signal to the electrical connector 50.

The electrical connector 50 is mounted on an end of the main body 10 and is coupled with the electronic circuit 40. The electrical connector 50 is made of flexible materials, such as polyimide or polyester film. In at least one embodiment, the electrical connector 50 includes a FPC (Flexible printed electronic circuit board). More specifically, A first end of the electrical connector 50 connects with the electronic circuit 40, a second end opposite to the first end of the electrical connector 50 extends outside of the main body 10. In addition, the second end has a port 51. The port 51 may be a USB (Universal Serial Bus) port for the electronic device. The port 51 outputs the electrical signals from the near field communication and wireless charging device 100 to outside.

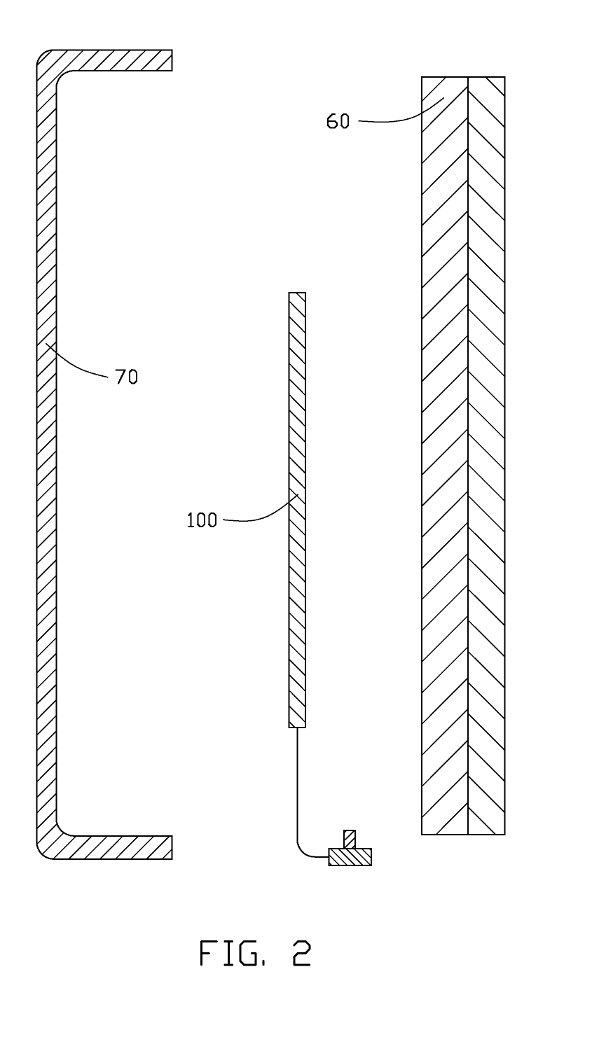

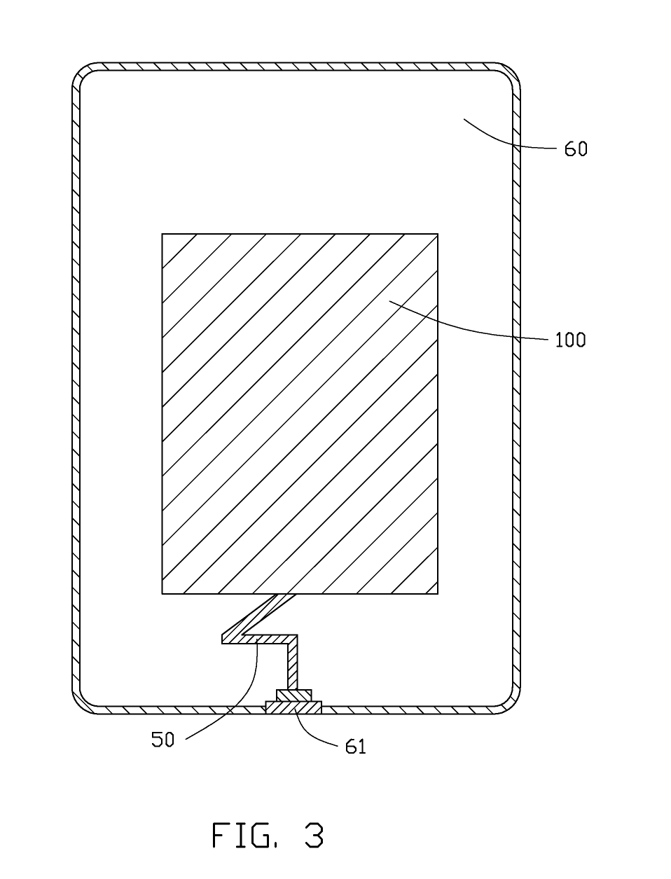

Referring to FIGS. 2-3, a protecting shell 70 and a electrical device 60 are provided in this embodiment, the protecting shell 70 cooperates with the electric device 60 and houses the electric device 60 therein. The near field communication and wireless charging device 100 of the present disclosure is attached on an outer surface of the protecting shell 70, or can be located between the electrical device 60 and the protecting shell 70. The near field communication and wireless charging device 100 electrically connects with a electrical device 60 via the port 51 of the electrical connector 50 inserting the USB port 61 of the electrical device 60.

Because the near field communication and wireless charging device 100 is configured for the electrical device 60, thereby, the near field communication and wireless charging device 100 makes the electronic circuit of the electrical device 60 simple. The electrical connector 50 of the near field communication and wireless charging device 100 is flexible, so the portable 100 is coupled with the electrical device 60 conveniently and has great flexibility. The NFC module 20 and the wireless charging module 30 are arranged independently to avoid interference of the NFC module 20 and the wireless charging module 30, so the NFC module 20 and the wireless charging module 30 have a high stability.

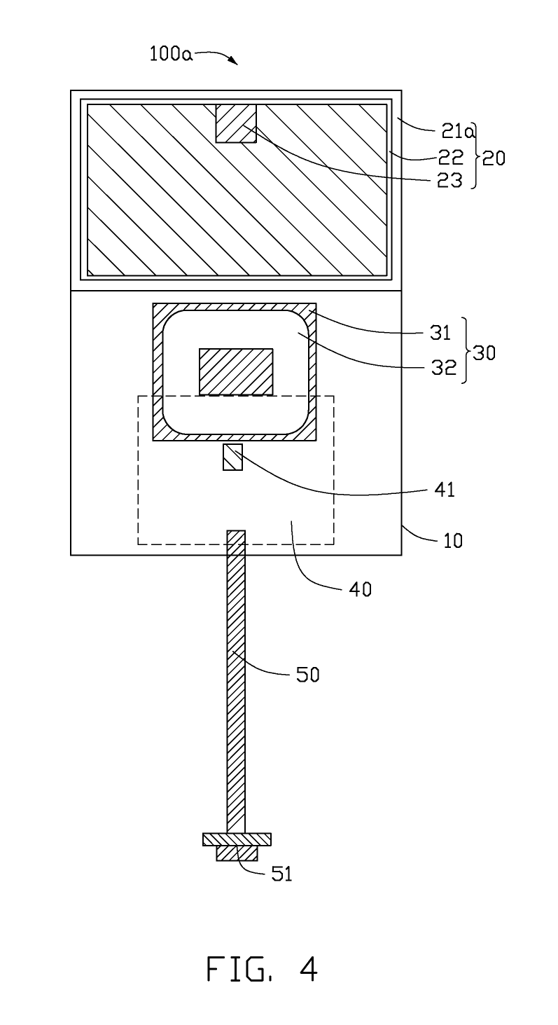

Referring to the FIG. 4, the near field communication and wireless charging device 100a of a second embodiment is similar to that of the first embodiment. The near field communication and wireless charging device 100a includes a spacer 21a, the spacer 21a is a plate. The wireless charging module 30 is arranged on an outside of the NFC coil 22.

The embodiments shown and described above are only examples. Many details are often found in the art such as the other features of a near field communication and wireless charging device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A near field communication and wireless charging device, comprising:
a main body, the main body having an exterior outer surface;
a near field communication (NFC) module coupled to the main body;
a wireless charging module coupled to the main body;
an electronic circuit posited within the main body, the electronic circuit connected to the NFC module and connected to the wireless charging module; and
an electronic electrical connector with a first end and a second end, the first end being connected to the electronic circuit and the second end extending beyond the exterior outer surface of the main body;
wherein, output from the NFC module or the wireless charging module may be outputted through the electrical electrical connector.

2. The near field communication and wireless charging device of claim 1, wherein the electrical connector is made of flexible materials, such as polyimide or polyester film.

3. The near field communication and wireless charging device of claim 1, wherein the second end extending out the main body of the electrical connector has a port.

4. The near field communication and wireless charging device of claim 3, wherein the port is a Universal Serial Bus port.

5. The near field communication and wireless charging device of claim 1, wherein a controlling unit is mounted on a side of the electronic circuit.

6. The near field communication and wireless charging device of claim 1, wherein the wireless charging module comprises a gasket and a receiving coil mounted on the gasket.

7. The near field communication and wireless charging device of claim 1, wherein the NFC module comprises a spacer, and a NFC coil and a NFC chip located on a side of the spacer.

8. The near field communication and wireless charging device of claim 7, wherein the wireless charging module is surrounded by the NFC coil.

9. The near field communication and wireless charging device of claim 7, wherein the NFC chip is coupled to the NFC coil.

10. The near field communication and wireless charging device of claim 7, wherein the wireless charging module is arranged on a outside of the NFC coil.

11. A near field communication and wireless charging device comprising:
a electronic circuit;
a NFC module and a wireless charging module coupled to the electronic circuit;
wherein, the near field communication and wireless charging device has a electrical connector, the electrical connector with a first end and a second end, the first end is configured to the electronic circuit, the second end of the electrical connector has a port to attaching to the electrical device.

12. The near field communication and wireless charging device of claim 11, wherein the electrical connector is made of flexible materials.

13. The near field communication and wireless charging device of claim 11, wherein a controlling unit is mounted on a side of the electronic circuit.
